(19) United States
(12) Patent Application Publication
(10) Pub. No.: US 2010/0115514 A1
(43) Pub. Date: May 6, 2010

(54) Mechanism for managing resources shared among virtual machines

(76) Inventor: Richard Maliszewski, Forest Grove, OR (US)

Correspondence Address: INTEL CORPORATION;c/o CPA Global, P.O. BOX 52050, MINNEAPOLIS, MN, 55402, US

(21) Appl. No.: 12/655,145

(22) Filed: Dec. 23, 2009

Related U.S. Application Data
(63) Continuation of application No. 11/070,360, filed on Mar. 2, 2005.

(51) Int. Cl. G06F 9/455; G06F 13/24; G06F 12/02

(52) U.S. Cl. 718/1; 710/260; 711/6

(57) ABSTRACT

According to one embodiment, a system is disclosed. The system includes a virtual machine monitor (VMM) having a vector of memory addresses to monitor one or more virtual machines, and a virtual machine to perform an operating environment and to access the vector of memory addresses associated with the VMM upon receiving an interrupt in order to service the interrupt.

### RELATED APPLICATIONS

This application is a continuation of and claims priority to U.S. patent application Ser. No. 11/070,360 filed Mar. 2, 2005 and entitled, “Mechanism for Managing Resources Shared Among Virtual Machines”; this application is entirely incorporated by reference.

### FIELD OF THE INVENTION

The present invention relates to computer systems; more particularly, the present invention relates to computer systems that may operate as multiple platforms.

### BACKGROUND

The implementation of virtual machines (VMs) enables a computer system to run different programs, and even different operating systems, at the same time. Often a computer system implementing VMs includes hardware support so that a VM is instantiated to enable an operating system and applications to operate in an isolated space. A virtual machine monitor (VMM) typically has access to each VM and associated resources.

A problem exists with computer systems operating VMs in that systems operating multiple VMs have to share and partition resources, such as interrupts and access to computer system hardware. For example, when an interrupt occurs at a VM, the VM is often exited enabling the VMM to forward the interrupt to the actual hardware. Subsequently, the VMM re-launches the VM by retrieving a stored state of the VM. As is readily apparent, having to undergo the various steps to service an interrupt may take a multitude of clock cycles, thus reducing system performance.

Current systems use “para-virtulization” to avoid the above-described problem. Para-virtulization involves the restructure of portions of an operating system to be aware that the operating system is running on virtual hardware. However, this solution includes modification of the operating system. Operating system modification poses various problems. One problem is that such modification may be precluded by a licensing agreement. Another problem may be that cooperation with the operating system vendor is required, and the vendor is not agreeable to the cooperation.

### BRIEF DESCRIPTION OF THE DRAWINGS

The invention is illustrated by way of example and not limitation in the figures of the accompanying drawings, in which like references indicate similar elements, and in which:

FIG. 1 is a block diagram of one embodiment of a computer system;

FIG. 2 is a diagram of one embodiment of a virtual environment; and

FIG. 3 is a flow diagram of one embodiment of servicing an interrupt; and

FIG. 4 is a block diagram of another embodiment of a computer system.

### DETAILED DESCRIPTION

A mechanism for managing resources shared among virtual machines is described. According to one embodiment, one or more virtual machines operating on a computer system are provided access to an address space allocated by a virtual machine monitor for the purposes of servicing various interrupts received at the virtual machines.

In the following detailed description of the present invention numerous specific details are set forth in order to provide a thorough understanding of the present invention. However, it will be apparent to one skilled in the art that the present invention may be practiced without these specific details. In other instances, well-known structures and devices are shown in block diagram form, rather than in detail, in order to avoid obscuring the present invention.

Reference in the specification to “one embodiment” or “an embodiment” means that a particular feature, structure, or characteristic described in connection with the embodiment is included in at least one embodiment of the invention. The appearances of the phrase “in one embodiment” in various places in the specification are not necessarily all referring to the same embodiment.

Some portions of the detailed descriptions that follow are presented in terms of algorithms and symbolic representations of operations on data bits within a computer memory. These algorithmic descriptions and representations are the means used by those skilled in the data processing arts to most effectively convey the substance of their work to others skilled in the art. An algorithm is here, and generally, conceived to be a self-consistent sequence of steps leading to a desired result. The steps are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the following discussion, it is appreciated that throughout the description, discussions utilizing terms such as “processing” or “computing” or “calculating” or “determining” or “displaying” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

The present invention also relates to an apparatus for performing the operations herein. This apparatus may be specially constructed for the required purposes, or it may comprise a general-purpose computer selectively activated or reconfigured by a computer program stored in the computer. Such a computer program may be stored in a computer readable storage medium, such as, but is not limited to, any type of disk including floppy disks, optical disks, CD-ROMs, and magnetic-optical disks, read-only memories (ROMs), random access memories (RAMs), EPROMs, EEPROMs, magnetic or optical cards, or any type of media suitable for storing electronic instructions, and each coupled to a computer system bus.

The algorithms and displays presented herein are not inherently related to any particular computer or other apparatus. Various general-purpose systems may be used with programs in accordance with the teachings herein, or it may prove convenient to construct more specialized apparatus to perform the required method steps. The required structure for a variety of these systems will appear from the description below. In addition, the present invention is not described with reference to any particular programming language. It will be appreciated that a variety of programming languages may be used to implement the teachings of the invention as described herein.

The instructions of the programming language(s) may be executed by one or more processing devices (e.g., processors, controllers, control processing units (CPUs).

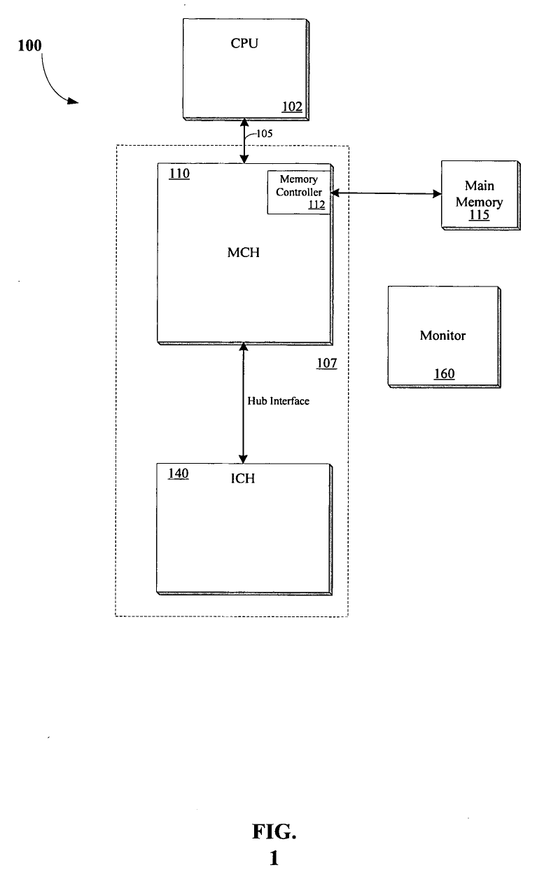

FIG. 1 is a block diagram of one embodiment of a computer system 100. Computer system 100 includes a central processing unit (CPU) 102 coupled to bus 105. In one embodiment, CPU 102 is a processor in the Pentium® family of processors Pentium® IV processors available from Intel Corporation of Santa Clara, Calif. Alternatively, other CPUs may be used. For instance, CPU 102 may be implemented multiple processors, or multiple processor cores.

In a further embodiment, a chipset 107 is also coupled to bus 105. Chipset 107 includes a memory control hub (MCH) 110. MCH 110 may include a memory controller 112 that is coupled to a main system memory 115. Main system memory 115 stores data and sequences of instructions that are executed by CPU 102 or any other device included in system 100. In one embodiment, main system memory 115 includes dynamic random access memory (DRAM); however, main system memory 115 may be implemented using other memory types. Additional devices may also be coupled to bus 105, such as multiple CPUs and/or multiple system memories.

MCH 110 is coupled to an input/output control hub (ICH) 140 via a hub interface. ICH 140 provides an interface to input/output (I/O) devices within computer system 100. ICH 140 may support standard I/O operations on I/O busses such as peripheral component interconnect (PCI), accelerated graphics port (AGP), universal serial bus (USB), low pin count (LPC) bus, or any other kind of I/O bus (not shown).

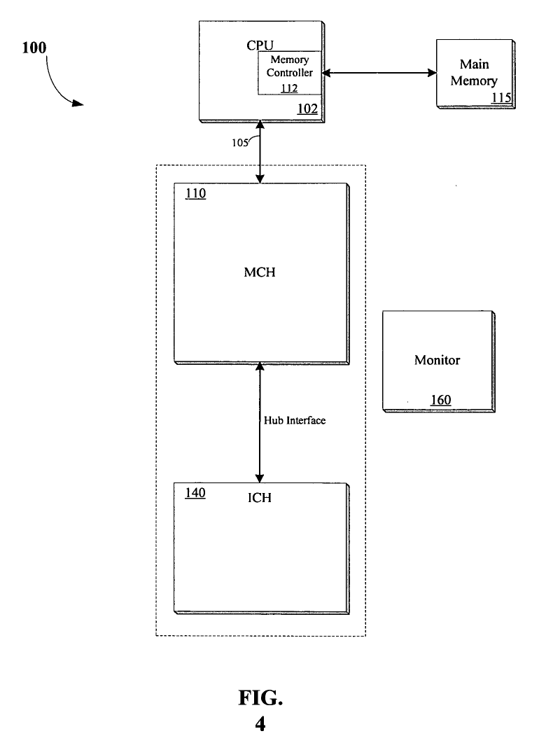

FIG. 4 illustrates another embodiment of computer system 100. In this embodiment, memory controller 112 is included within CPU 102, as a result memory 115 is coupled to CPU 102.

According to one embodiment, a Virtual Machine Monitor (VMM) 160 may be stored on a system disk or other mass storage, and moved or copied to other locations as necessary. In one embodiment, upon startup of computer system 100 VMM 160 may be moved or copied to one or more memory pages in memory 115. Subsequently, a virtual machine environment may be created in which VMM 160 may operate as the most privileged code within the system, and may be used to permit or deny direct access to certain system resources by the operating system or applications within the created virtual machines.

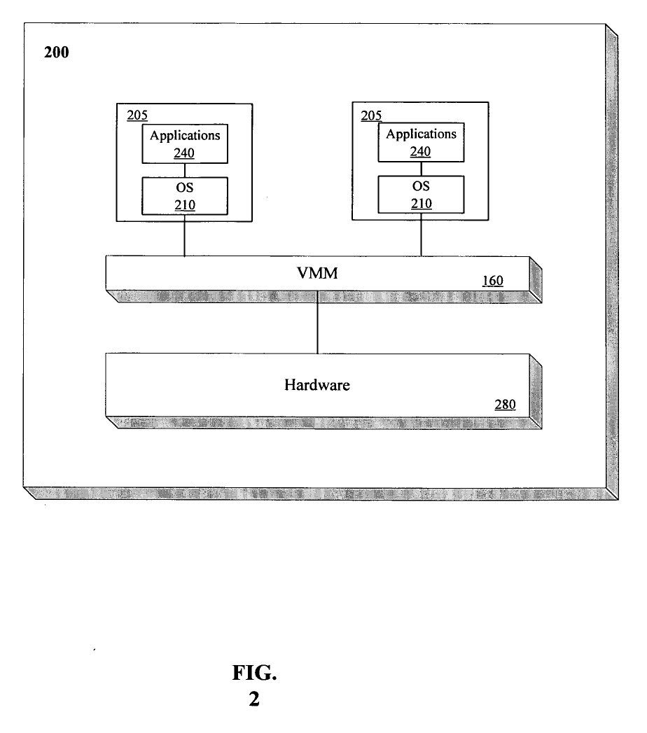

FIG. 2 illustrates one embodiment of a virtual machine platform 200. In the FIG. 2 embodiment, operating systems and software may be loaded simultaneously and may execute simultaneously on a single computer system. VMM 160 manages the operation of platform 200. Particularly, VMM 160 permits or prevents direct access to hardware resources 280 from one or more virtual machines (VMs) 205. VMs 205 are self-contained operating environments that operate as if each is a separate computer system. Thus, each VM 205 includes an operating system 210 and one or more software applications 240. In addition, VMs 205 each include segregated resources (e.g., memory) that may only be accessed by the particular VM 205.

As discussed above, interrupts received at a VM typically cause a VM exit, thus allowing the VMM to manage how the interrupt is processed. Such VM exits reduce system performance. According to one embodiment, VMM 160 provides access to VMM 160 resources to a VM 205 to enable the VM 205 to service received interrupts without exiting. Particularly, VM 205 is provided access to address space allocated for VMM 160 for the purposes of servicing an interrupt received at VM 205. In such an embodiment, VM 205 can access the VMM 160 address space upon receiving an interrupt. Further, VMM 205 may not modify the address space.

In order to enable a VM 205 to access its resources, VMM 160 includes a vector of addresses to which control can be transferred upon interrupts received in a VM 205 execution context. In a further embodiment, support is provided for the allocation of memory that is only reachable through an interrupt vector. In this embodiment, VMM 160 programs are written in a non-proprietary manner such that there is no negative aspect in a VM 205 having access. However in other embodiments, the VMM 160 memory space may be configured so that it may not be accessed by user level programs.

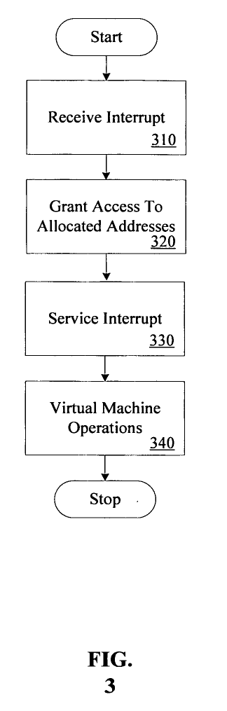

FIG. 3 is a flow diagram for one embodiment of servicing an interrupt received at a VM 205. At processing block 310, a VM 205 receives an interrupt. At processing block 310, VM 205 is directed to a vector of addresses allocated for VMM 160 in order to service the interrupt. At processing block 330, the interrupt is serviced by VM 205. At processing block 340, VM 205 resumes normal operation.

Whereas many alterations and modifications of the present invention will no doubt become apparent to a person of ordinary skill in the art after having read the foregoing description, it is to be understood that any particular embodiment shown and described by way of illustration is in no way intended to be considered limiting. Therefore, references to details of various embodiments are not intended to limit the scope of the claims, which in themselves recite only those features regarded as essential to the invention.

What is claimed is:

1. A method, comprising:
receiving an interrupt directed to a virtual machine at a virtual machine monitor; and
the virtual machine monitor servicing the interrupt directly upon receipt.

2. The method of claim 1, further comprising:
allocating system resources to the virtual machine using a vector of memory addresses, the vector of memory addresses storing at least a portion of an operating environment for the virtual machine.

3. The method of claim 2, further comprising:
causing the virtual machine to relinquish control of the system resources upon receipt of the interrupt at the virtual machine monitor.

4. The method of claim 3, further comprising:
the virtual machine monitor utilizing at least a portion of the system resources allocated to the virtual machine to service the interrupt.

5. An apparatus, comprising:
a hardware device to generate an interrupt;
a system memory to store a virtual machine and a virtual machine monitor, wherein the virtual machine monitor is operable to
receive an interrupt directed to the virtual machine; and
service the interrupt directly upon receipt.

6. The apparatus of claim 5, wherein the virtual machine monitor is further operable to:
allocate system resources to the virtual machine using a vector of memory addresses, the vector of memory addresses to store at least a portion of an operating environment for the virtual machine.

7. The apparatus of claim 6, wherein the virtual machine monitor is further operable to:
cause the virtual machine to relinquish control of the system resources upon receipt of the interrupt at the virtual machine monitor.

8. The apparatus of claim 7, wherein the virtual machine monitor is further operable to:
utilize at least a portion of the system resources allocated to the virtual machine to service the interrupt.

9. A method, comprising:
receiving an interrupt at a virtual machine;
remapping physical memory addresses to the virtual machine for the purpose of servicing an interrupt received at the virtual machine; and
servicing the interrupt from the virtual machine.

10. The method of claim 9, further comprising:
the virtual machine resuming operation after the interrupt has been serviced.
